(19) United States
(12) Patent Application Publication
(10) Pub. No.: US 2012/0158605 A1
(43) Pub. Date: Jun. 21, 2012

(54) CREATING A DYNAMIC ACCOUNT STORING AGGREGATED SOCIAL DATA TO ASSIST CUSTOMER KNOWLEDGE

(75) Inventors: Marcus L. Belvin, Raleigh, NC (US); Henri F. Meli, Cary, NC (US); M. Scott Thomason, Raleigh, NC (US); Yingxin Xing, Durham, NC (US); Tong Yu, Cary, NC (US)

(73) Assignee: INTERNATIONAL BUSINESS MACHINES CORPORATION, Armonk, NY (US)

(21) Appl. No.: 12/968,871

(22) Filed: Dec. 15, 2010

(51) Int. Cl. G06Q 99/00

(52) U.S. Cl. 705/319

(57) ABSTRACT

A method, system and computer program product for assisting customer knowledge using social media data. Responses to text-based posts regarding compatibility of an updated product with respect to other products/components in a complex product environment are aggregated and used to create what is referred to herein as a “dynamic account.” The dynamic account contains information regarding the compatibility of an updated product from a particular vendor/company with other products from other vendors/companies, where these products are used in combination in a complex product environment. This knowledge base may be used by users of a social network system who are customers of these companies to keep them informed regarding compatibility issues when an update to a product occurs.

### TECHNICAL FIELD

The present invention relates to social network services, and more particularly to creating a dynamic account storing aggregated social data to assist customer knowledge in understanding how an update to a product from one vendor will affect other products or components from others vendors in the complex product environment.

### BACKGROUND

A social network service is an online service, platform or site that focuses on building and reflecting of social networks or social relations among people (e.g., those who share interests and/or activities). A social network service essentially consists of a representation of each user (often a profile), his/her social links, and a variety of additional services. Most social network services are web based and provide means for users to interact over the Internet, such as by e-mail and instant messaging. Social networking sites allow users to share ideas, activities, events, and interests within their individual networks.

By way of example, but not limited to, Twitter® is a website which offers a social networking and microblogging service, enabling its users to send and read other users' messages called “tweets.” Tweets are text-based posts of up to 140 characters displayed on the user's profile page. Tweets are publicly visible by default; however, senders can restrict message delivery to their friend list. Users may subscribe to other users' tweets. This is known as following and subscribers are known as “followers.” All users can send and receive tweets via the Twitter website, compatible external applications (such as for smartphones), or by Short Message Service (SMS) available in certain countries.

Businesses of recent years are starting to leverage these social network services as a means to improve communication with their customers and improve customer satisfaction. Businesses will create an account with one of these social networking service providers and their customers (“followers”) will follow them and vice-versa. Businesses can notify/update their followers about new offerings and/or about important patches/fixes made to their existing products.

However, a company's product is usually a component within a complex product environment. For example, a complex product environment may include multiple products or components from different vendors or companies. For instance, a complex software environment may include an application server from company A, a database product from company B and an operating system from company C.

If a specific vendor notifies their followers regarding an update (e.g., patch) to their product, they may not be able to inform the customer how this update will affect the other components in the customer's specific complex product environment. For example, a customer may receive a text-based post from a company regarding a newer version of an operating system. They have not informed the customer whether this newer version is compatible with other components in the customer's software product environment, such as the browser or application server from different vendors.

Hence, a customer who receives a text-based post from a company regarding an update to a product does not currently know how this update will affect other products or components from different vendors in the complex product environment.

### BRIEF SUMMARY

In one embodiment of the present invention, a method for assisting customer knowledge using social media data comprises delivering a first text-based post regarding an update to a first product of a first company to followers of the first company. The method further comprises receiving a second text-based post from one of the followers of the first company regarding compatibility of the updated first product with one or more other products from one or more other companies. Additionally, the method comprises delivering the second text-based post to the followers of the first company. In addition, the method comprises receiving one or more responses to the second text-based post from one or more of the followers of the first company regarding compatibility of the updated first product with one or more other products from one or more other companies. The method further comprises aggregating the one or more responses. Furthermore, the method comprises creating a dynamic account, by a processor of a social network server, containing information learned from the aggregated responses regarding compatibility of the updated first product with one or more other products from one or more other companies.

Other forms of the embodiment of the method described above are in a system and in a computer program product.

In another embodiment of the present invention, a method for assisting customer knowledge using social media data comprises determining that a user is a follower of a plurality of companies. The method further comprises determining that one or more products from each of the plurality of companies are used in combination in an environment. Furthermore, the method comprises determining that a dynamic account containing information regarding compatibility of one or more products from each of the plurality of companies exist. In addition, the method comprises issuing a recommendation to the user to subscribe to the dynamic account.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a social network system configured in accordance with an embodiment of the present invention;

FIG. 2 illustrates a hardware configuration of a social network server configured in accordance with an embodiment of the present invention;

FIG. 3 illustrates the concept of followers in accordance with an embodiment of the present invention;

FIG. 4 is a flowchart of a method for establishing a dynamic account in accordance with an embodiment of the present invention;

FIG. 5 is a flowchart of a method for recommending a user to subscribe to the dynamic account in accordance with an embodiment of the present invention; and

FIG. 6 is a flowchart of a method for adding subscribers to the dynamic account in accordance with an embodiment of the present invention.

### DETAILED DESCRIPTION

The present invention comprises a method, system and computer program product for assisting customer knowledge using social media data. In one embodiment of the present invention, responses to text-based posts regarding compatibility of an updated product with respect to other products/components in a complex product environment are aggregated and used to create what is referred to herein as a “dynamic account.” The dynamic account contains information regarding the compatibility of an updated product from a particular vendor/company with other products from other vendors/companies, where these products are used in combination in a complex product environment. This knowledge base may be used by users of a social network system who are customers of these companies to keep them informed regarding compatibility issues when an update to a product occurs.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

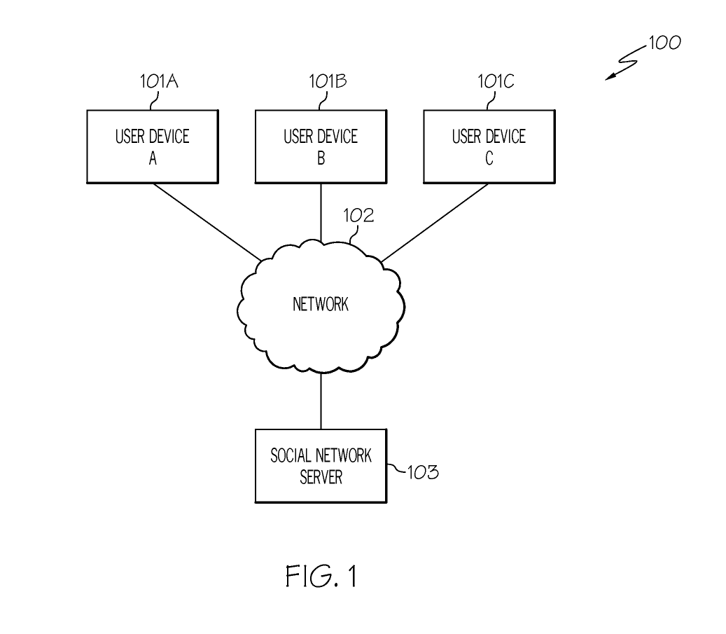

Referring now to the Figures in detail, FIG. 1 illustrates a social network system 100 configured in accordance with an embodiment of the present invention. Referring to FIG. 1, social network system 100 includes a community of users, including companies/businesses, using devices 101A-101C (identified as “User Device A,” “User Device B,” and “User Device C,” respectively, in FIG. 1) to be involved in social network system 100. User devices 101A-101C may collectively or individually be referred to as user devices 101 or user device 101, respectively. User device 101 may be a computing system, a mobile phone, a cellular phone, a smart-phone, a personal digital assistance (PDA), a gaming unit, a portable computing unit, and the like. System 100 may include any number of user devices 101 and the depiction of three user devices 101A-101C in FIG. 1 is for illustrative purposes.

Users of user devices 101 may participate in the social network by communicating (by wire or wirelessly) over a network 102, which may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

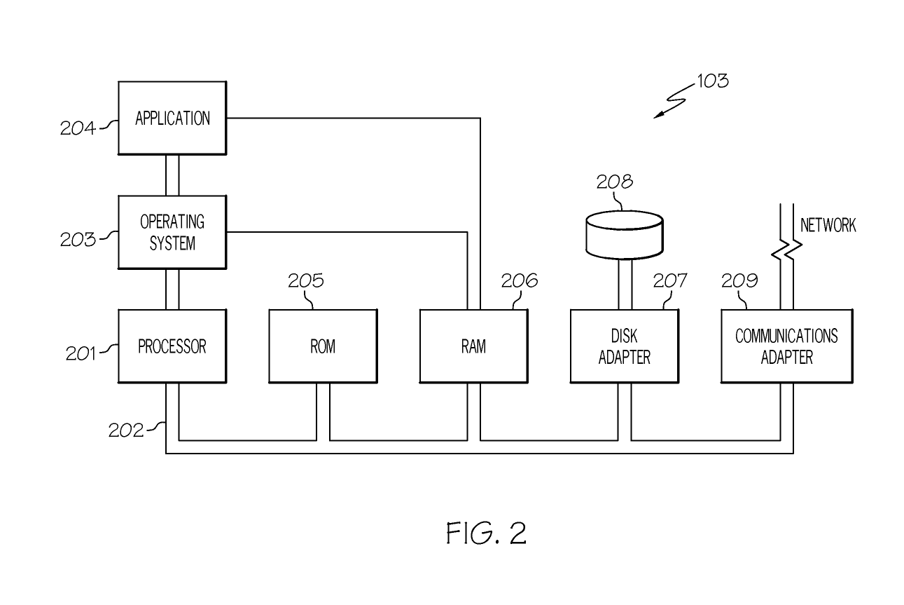

System 100 further includes a social network server 103, which may be a web server configured to offer a social networking and/or microblogging service, enabling users of user devices 101 to send and read other users' text-based posts. Furthermore, social network server 103 may be configured to store user profiles and accounts of users involved in social networking groups. Social network server 103 is connected to network 102 by wire or wirelessly. While FIG. 1 illustrates a single social network server 103, it is noted for clarity that multiple servers may be used to implement the social networking and/or microblogging service. Furthermore, each server may have different functions (e.g., a server configured to store user profiles, a web server to run the social network site). Additionally, user profiles and accounts may be stored in one or more databases (not shown) connected to social network server 103. A description of one embodiment of a hardware configuration of social network server 103 used to assist user/customer knowledge using social media data is provided below in connection with FIG. 2.

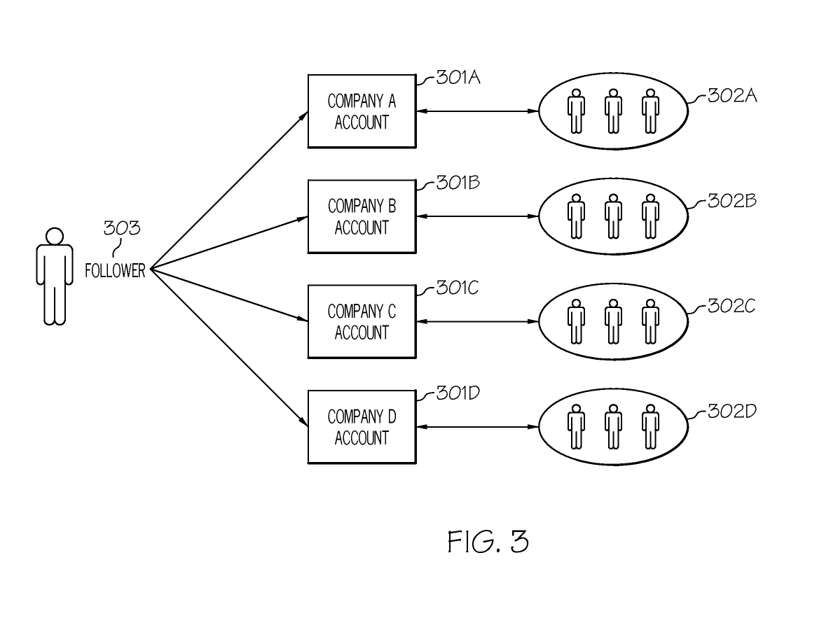

Referring now to FIG. 2, FIG. 2 illustrates a hardware configuration of a social network server 103 (FIG. 1) which is representative of a hardware environment for practicing the present invention. Referring to FIG. 2, social network server 103 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for assisting user/customer knowledge using social media data, as discussed further below in association with FIGS. 3-6.

Referring again to FIG. 2, read-only memory (“ROM”) 205 is coupled to system bus 202 and includes a basic input/output system (“BIOS”) that controls certain basic functions of social network server 103. Random access memory (“RAM”) 206 and disk adapter 207 are also coupled to system bus 202. It should be noted that software components including operating system 203 and application 204 may be loaded into RAM 206, which may be social network server's 103 main memory for execution. Disk adapter 207 may be an integrated drive electronics (“IDE”) adapter that communicates with a disk unit 208, e.g., disk drive. It is noted that the program for assisting user/customer knowledge using social media data, as discussed further below in association with FIGS. 3-6, may reside in disk unit 208 or in application 204.

Social network server 103 may further include a communications adapter 209 coupled to bus 202. Communications adapter 209 interconnects bus 202 with an outside network (network 102) thereby enabling social network server 103 to communicate with users of user devices 101, such as delivering text-based posts to the author's subscribers or followers.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, if a specific vendor notifies their followers regarding an update (e.g., patch) to their product, they may not be able to inform the customer how this update will affect the other components in the customer's specific complex product environment. For example, a customer may receive a text-based post from a company regarding a newer version of an operating system. They have not informed the customer whether this newer version is compatible with other components in the customer's software product environment, such as the browser or application server from different vendors. Hence, a customer who receives a text-based post from a company regarding an update to a product does not currently know how this update will affect other products or components from different vendors in the complex product environment.

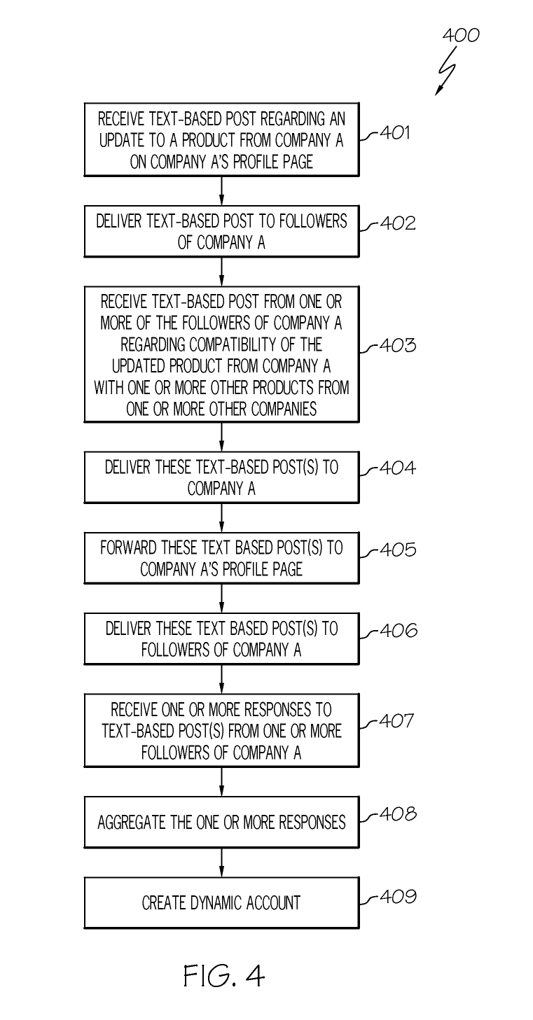

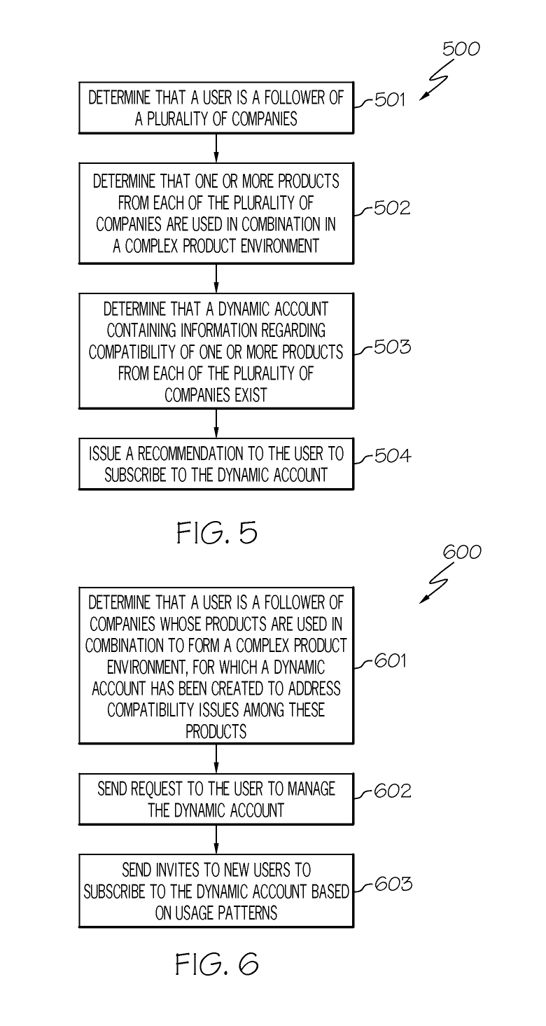

The principles of the present invention provide a means for establishing a knowledge base containing aggregated social media which is used to assist the user/customer from knowing how an updated product will affect other products or components from different vendors in the complex product environment as discussed below in connection with FIGS. 3-6. FIG. 3 illustrates the concept of followers. FIG. 4 is a flowchart of a method for establishing a “dynamic account,” which contains information regarding the compatibility of an update to a product from a particular vendor/company with other products from other vendors/companies, where these products are used in combination in a complex product environment. FIG. 5 is a flowchart of a method for recommending a user to subscribe to a dynamic account. FIG. 6 is a flowchart of a method for adding subscribers to the dynamic account.

Referring to FIG. 3, in conjunction with FIGS. 1-2, as stated above, FIG. 3 illustrates the concept of followers in accordance with an embodiment of the present invention. A “follower” may refer to a user of user device 101 who subscribes to receive text-based posts from a particular author (e.g., a company). For instance, companies may create accounts 301A-301D (identified as “Company A Account,” “Company B Account,” “Company C Account,” and “Company D Account,” respectively, in FIG. 3) with the social network service provider (e.g., Twitter®). Once a company creates an account with the social network service provider, the company may post text-based posts on its profile page, which may be delivered to the author's subscribers or followers by the social network service provider, such as social network server 103. For example, company A may have followers 302A, company B may have followers 302B, company C may have followers 302C and company D may have followers 302D.

As discussed above, a customer may use a complex product environment that includes products from various vendors. For instance, suppose that follower 303 uses a complex product environment that includes components from companies A, B, C and D. If the customer is concerned about how an update to a product from one of these companies will affect the other products or components from the other companies in the complex product environment, then the customer may become a follower of each of these companies as illustrated in FIG. 3. As will be discussed further below, follower 303 may no longer need to subscribe to each of these companies individually, as illustrated in FIG. 3, but instead subscribe to a single account (“dynamic account”) which contains information regarding the compatibility of the products of these companies used in combination. A description of creating the dynamic account is provided below in connection with FIG. 4.

FIG. 4 is a flowchart of a method 400 for establishing a “dynamic account,” which contains information regarding the compatibility of an updated product from a particular vendor/company with other products from other vendors/companies, where these products are used in combination in a complex product environment, in accordance with an embodiment of the present invention.

Referring to FIG. 4, in conjunction with FIGS. 1-3, in step 401, social network server 103 receives a text-based post regarding an update to a product from Company A on Company A's profile page. An update, as used herein, refers to any modification of the product, such as a patch, revision, adjustment, alteration, conversion, correction, improvement, etc., made by the company. For ease of understanding, the company is identified as “Company A” corresponding to the company that set-up the account labeled “Company A Account” 301A. Any company may have been used and the use of Company A is used for illustrative purposes.

In step 402, social network server 103 delivers the text-based post to the followers (e.g., followers 302A, 303) of Company A.

In step 403, social network server 103 receives a text-based post from one or more of the followers (e.g., follower 303) of Company A regarding the compatibility of the updated product from Company A with one or more other products from one or more other companies that are used in combination to form a complex product environment. In these text-based post(s), the follower(s) would like to know how this updated product will affect the other products/components in the follower's specific complex product environment. For example, suppose that Company A issued a text-based post regarding a newer version of the operating system. The follower may want to know whether this newer version of the operating system is compatible with other components in the customer's software product environment, such as the browser and application server from different vendors.

In step 404, social network server 103 delivers these text-based post(s) received in step 403 to Company A. Assuming that Company A does not know the answer regarding whether the updated product from Company A is compatible with one or more other products from one or more other companies that are used in combination to form a complex product environment, then Company A may post this text-based message on its profile page which will later be shared among its followers to see if any of its followers know the answer.

In step 405, social network server 103 forwards these text-based post(s) received in step 403 to Company A's profile page. In step 406, social network 103 delivers these text-based post(s) to the followers (e.g., followers 302A, 303) of Company A.

In step 407, social network server 103 receives one or more responses to these text-based posts(s) from one or more followers (e.g., followers 302A, 303) of Company A providing information regarding how this updated product from Company A will affect the other components in a specific complex product environment. This information is valuable and could be used by other customers who have concerns regarding the compatibility of the updated product with the same components in the same complex product environment. As a result, such information should be stored so that other users can leverage this knowledge. Such information is stored in an account, referred to herein, as the dynamic account.

In step 408, social network server 103 aggregates the responses to these text-based posts (in the case of receiving more than one response) that are received in step 407. In step 409, social network server 103 creates the dynamic account (real or virtual) storing the information learned from these responses in connection with the compatibility of the updated product with other components in the complex product environment. For example, the dynamic account may contain information regarding the compatibility of products/components from vendors Company A, Company B, Company C and Company D in a complex product environment. Instead of having a follower, such as follower 303, individually follow Companies A, B, C and D, as shown in FIG. 3, follower 303 may simply subscribe to the dynamic account, which contains information regarding the compatibility of the products of these companies used in combination.

In some implementations, method 400 may include other and/or additional steps that, for clarity, are not depicted. Further, in some implementations, method 400 may be executed in a different order presented and that the order presented in the discussion of FIG. 4 is illustrative. Additionally, in some implementations, certain steps in method 400 may be executed in a substantially simultaneous manner or may be omitted.

Once the dynamic account is created, social network server 103 may recommend a user to subscribe to the dynamic account as discussed below in connection with FIG. 5.

FIG. 5 is a flowchart of a method 500 for recommending a user to subscribe to the dynamic account in accordance with an embodiment of the present invention.

Referring to FIG. 5, in conjunction with FIGS. 1-3, in step 501, social network server 103 determines that a user (referring to a community user, such as a user of user device 101) is a follower of a plurality of companies, such as from usage patterns. For example, as illustrated in FIG. 3, follower 303 subscribes to be a follower of companies A, B, C and D.

In step 502, social network server 103 determines that one or more products from each of these companies are used in combination in a complex product environment. In one embodiment, such a determination may be made based on information provided by the customers or followers of various companies. Such information may be stored in a database (not shown) connected to social network server 103.

In step 503, social network server 103 determines that a dynamic account containing information regarding the compatibility of one or more products from each of these companies that are used in combination to form a complex product environment exists.

In step 504, social network server 103 issues a recommendation to the user identified in step 501 to subscribe to this dynamic account to leverage the knowledge stored in this account so as to assist the user in understanding any compatibility issues with the products of these companies that form a complex product environment rather than attempting to understand such a compatibility issue by individually subscribing to each of these companies.

In some implementations, method 500 may include other and/or additional steps that, for clarity, are not depicted. Further, in some implementations, method 500 may be executed in a different order presented and that the order presented in the discussion of FIG. 5 is illustrative. Additionally, in some implementations, certain steps in method 500 may be executed in a substantially simultaneous manner or may be omitted.

In addition to recommending a user to subscribe to the dynamic account, social network server 103 adds subscribers to the dynamic account as discussed below in connection with FIG. 6.

FIG. 6 is a flowchart of a method 600 for adding subscribers to the dynamic account in accordance with an embodiment of the present invention.

Referring to FIG. 6, in conjunction with FIGS. 1-3, in step 601, social network server 103 determines that a user is a follower of companies whose products are used in combination to form a complex product environment, for which a dynamic account has been created to address compatibility issues among these products. In one embodiment, this user may be one of the followers that raised one of the questions regarding compatibility issues (e.g., step 403) that resulted in the creation of the dynamic account.

In step 602, social network server 103 sends a request to the user to manage this dynamic account.

In step 603, social network server 103 sends invites to new users to subscribe to the dynamic account based on usage patterns, such as followers (e.g., follower 303) who subscribe to the majority or each of the companies (e.g., companies A, B, C and D) whose products are used in combination to form a complex product environment, for which a dynamic account has been created to address compatibility issues among these products.

In some implementations, method 600 may include other and/or additional steps that, for clarity, are not depicted. Further, in some implementations, method 600 may be executed in a different order presented and that the order presented in the discussion of FIG. 6 is illustrative. Additionally, in some implementations, certain steps in method 600 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1-7. (canceled)

8. A computer program product embodied in a computer readable storage medium for assisting customer knowledge using social media data, the computer program product comprising the programming instructions for:
delivering a first text-based post regarding an update to a first product of a first company to followers of said first company;
receiving a second text-based post from one of said followers of said first company regarding compatibility of said updated first product with one or more other products from one or more other companies;
delivering said second text-based post to said followers of said first company;
receiving one or more responses to said second text-based post from one or more of said followers of said first company regarding compatibility of said updated first product with said one or more other products from said one or more other companies;
aggregating said one or more responses; and
creating a dynamic account containing information learned from said aggregated responses regarding compatibility of said updated first product with said one or more other products from said one or more other companies.

9. The computer program product as recited in claim 8, wherein said first product of said first company and said one or more other products from said one or more other companies are used in combination in a software environment.

10. The computer program product as recited in claim 8 further comprising the programming instructions for:
determining that a user is a follower of said first company and said one or more other companies; and
sending a request to said user to manage said dynamic account.

11. The computer program product as recited in claim 10 further comprising the programming instructions for:
sending invites to new users to subscribe to said dynamic account based on usage patterns.

12. A system, comprising:
a memory unit for storing a computer program for assisting customer knowledge using social media data; and
a processor coupled to said memory unit, wherein said processor, responsive to said computer program, comprises:
circuitry for delivering a first text-based post regarding an update to a first product of a first company to followers of said first company;
circuitry for receiving a second text-based post from one of said followers of said first company regarding compatibility of said updated first product with one or more other products from one or more other companies;
circuitry for delivering said second text-based post to said followers of said first company;
circuitry for receiving one or more responses to said second text-based post from one or more of said followers of said first company regarding compatibility of said updated first product with said one or more other products from said one or more other companies;
circuitry for aggregating said one or more responses; and
circuitry for creating a dynamic account containing information learned from said aggregated responses regarding compatibility of said updated first product with said one or more other products from said one or more other companies.

13. The system as recited in claim 12, wherein said first product of said first company and said one or more other products from said one or more other companies are used in combination in a software environment.

14. The system as recited in claim 12, wherein said processor further comprises:
circuitry for determining that a user is a follower of said first company and said one or more other companies; and
circuitry for sending a request to said user to manage said dynamic account.

15. The system as recited in claim 14, wherein said processor further comprises:
circuitry for sending invites to new users to subscribe to said dynamic account based on usage patterns.

16. A computer program product embodied in a computer readable storage medium for assisting customer knowledge using social media data, the computer program product comprising the programming instructions for:
determining that a user is a follower of a plurality of companies;
determining that one or more products from each of said plurality of companies are used in combination in an environment;
determining that a dynamic account containing information regarding compatibility of one or more products from each of said plurality of companies exist; and
issuing a recommendation to said user to subscribe to said dynamic account.

17. The computer program product as recited in claim 16 further comprising the programming instructions for:
sending a request to said user to manage said dynamic account.

18. The computer program product as recited in claim 16 further comprising the programming instructions for:
sending invites to new users to subscribe to said dynamic account based on usage patterns.

19. A system, comprising:
a memory unit for storing a computer program for assisting customer knowledge using social media data; and
a processor coupled to said memory unit, wherein said processor, responsive to said computer program, comprises:
circuitry for determining that a user is a follower of a plurality of companies;
circuitry for determining that one or more products from each of said plurality of companies are used in combination in an environment;
circuitry for determining that a dynamic account containing information regarding compatibility of one or more products from each of said plurality of companies exist; and
circuitry for issuing a recommendation to said user to subscribe to said dynamic account.

20. The system as recited in claim 19, wherein said processor further comprises:
circuitry for sending a request to said user to manage said dynamic account.

21. The system as recited in claim 19, wherein said processor further comprises:
circuitry for sending invites to new users to subscribe to said dynamic account based on usage patterns.
